(19) United States
(12) Patent Application Publication
(10) Pub. No.: US 2020/0397646 A1
(43) Pub. Date: Dec. 24, 2020

(54) Massage Machine

(71) Applicant: Fuji Medical Instruments Mfg. Co., Ltd., Osaka (JP)

(72) Inventor: Shogo KODAMA, Osaka (JP)

(73) Assignee: Fuji Medical Instruments Mfg. Co., Ltd., Osaka (JP)

(21) Appl. No.: 16/785,430

(22) Filed: Feb. 7, 2020

(30) Foreign Application Priority Data
Jun. 19, 2019 (JP) 2019-113590

(51) Int. Cl. A61H 9/00

(52) U.S. Cl. CPC A61H 9/0078; A61H 2201/0149; A61H 2201/5097; A61H 2201/5025; A61H 2205/06; A61H 2201/5046

(57) ABSTRACT

A massage machine includes a seat on which a person to be treated sits, and a side wall part disposed at the outside of the seat in a left and right direction. The side wall part includes a medical treatment unit configured to provide medical treatment for a specific body part of the person to be treated who sits on the seat, and an operation unit disposed and fixed to the inside or the outside of the medical treatment unit in the left and right direction.

### CROSS-REFERENCE TO RELATED APPLICATIONS

This nonprovisional application claims priority under 35 U.S.C. § 119(a) on Patent Application No. 2019-113590 filed in Japan on Jun. 19, 2019, the entire contents of which are hereby incorporated by reference.

### BACKGROUND OF THE INVENTION

### Field of the Invention

The present invention relates to a chair type massage machine.

### Description of Related Art

Conventionally, there is known a chair type massage machine equipped with a movable operation device that receives external operation by a person to be treated or other person.

For instance, a chair type massage machine disclosed in JP-A-2004-33361 includes a connection support part that connects a remote controller to a backrest part so as to support the same. The connection support part is constituted of a flexible arm that can be bent.

Further, a chair type massage machine disclosed in JP-A-2018-149096 includes an operation device disposed at a top end of a support member extending outward from a pedestal of a seat. The operation device is attached to the support member via an attitude changing mechanism. The operation device can be tilted with the attitude changing mechanism in an arbitrary direction.

### SUMMARY OF THE INVENTION

If the operation device is movable as disclosed in JP-A-2004-33361 or JP-A-2018-149096, it is convenient for the person to be treated, since the operation device can be moved in a direction such that it can be easily viewed or it can be easily reached.

However, in the structure of JP-A-2004-33361 or JP-A-2018-149096, for example, the person to be treated is required to set a position of the operation device every time when the position of the operation device is not appropriate, and the person to be treated may feel this setting operation as troublesome. On the other hand, if the setting of the position of the operation device by the person to be treated is omitted, the operation device may be felt as an obstacle after the treatment is started, or it may be felt that the operation is difficult to perform.

In view of the above-mentioned situation, it is an object of the present invention to provide a massage machine that can be comfortably operated by a person to be treated.

A massage machine as an example of the present invention includes a seat on which a person to be treated sits, and a side wall part disposed at the outside of the seat in a left and right direction. The side wall part includes a medical treatment unit configured to provide medical treatment for a specific body part of the person to be treated who sits on the seat, and an operation unit disposed and fixed to the inside or the outside of the medical treatment unit in the left and right direction.

### BRIEF DESCRIPTION OF THE DRAWINGS

FIG. 1 is a schematic perspective view of a massage machine according to an embodiment of the present invention.

FIG. 2A is a schematic plan view illustrating a forearm medical treatment unit for right hand and its vicinity.

FIG. 2B is a schematic plan view illustrating the forearm medical treatment unit for right hand and its vicinity.

FIG. 3 is a schematic plan view illustrating an operation unit and its vicinity.

FIG. 4 is a schematic view illustrating a part of a right side wall part, at which the operation unit is disposed, viewed from the front.

FIG. 5 is a block diagram illustrating a structure of the massage machine according to the embodiment of the present invention.

FIG. 6 is a schematic diagram illustrating a structure of the operation unit.

### DETAILED DESCRIPTION OF THE PREFERRED EMBODIMENTS

Now, an embodiment of the present invention as an example thereof is described in detail with reference to the drawings.

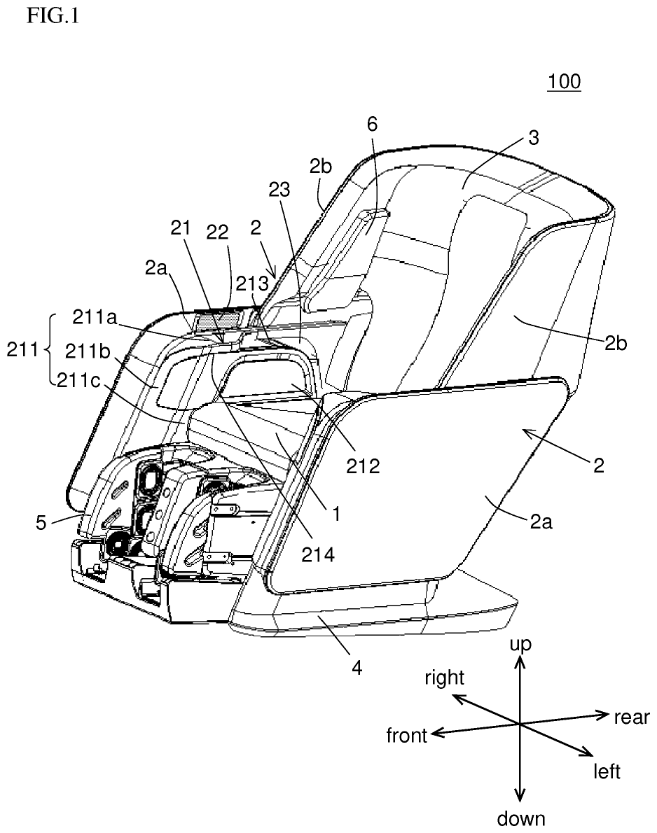

FIG. 1 is a schematic perspective view of a massage machine 100 according to an embodiment of the present invention. As illustrated in FIG. 1, the massage machine 100 includes a seat 1 and side wall parts 2. The massage machine 100 further includes a back part 3, a pedestal part 4, and a footrest part 5.

In the following description, front side and back side (rear side) are defined as viewed from a person to be treated sitting on the seat 1. Further, upper side (head side) and lower side (leg side) are defined as viewed from the person to be treated sitting on the seat 1. Further, right side and left side are defined as viewed from the person to be treated sitting on the seat 1. Note that the back part 3 may have a reclining function of reclining backward, but still the expressions “front side and back side”, “upper side and lower side” and “right side and left side” are used supposing that the back part 3 is in a predetermined position without being reclined backward with the reclining function. Further, the inside in the left and right direction means a direction approaching the center line in the left and right direction of the seat 1 in a plan view from above. The outside in the left and right direction means a direction separating from the center line in the left and right direction of the seat 1 in a plan view from above.

<1. Outline of Massage Machine 100>

The seat 1 is a part of the massage machine 100, on which the person to be treated sits. Specifically, the seat 1 supports hip and thigh of the person to be treated. Note that an inflatable bag that can inflate and deflate may be embedded in the seat 1. The inflatable bag is typically an air bag. If the inflatable bag is embedded in the seat 1, medical treatment for hip and thigh can be performed.

The side wall part 2 is disposed at the outside of the seat 1 in the left and right direction. The side wall part 2 is a separate body from the seat 1 and is positioned at the outside of the seat 1 in the left and right direction. In the massage machine 100, the side wall part 2 is disposed on each of the left and right sides of the seat 1. Details of the side wall part 2 will be described later.

The back part 3 is disposed in the back of the seat 1. Specifically, the back part 3 is attached to the back end of the seat 1 in such a manner that it can rotate about a reclining rotation axis extending in the left and right direction. The back part 3 is provided with a massage unit (not shown). The massage unit includes medical treatment elements, a rubbing drive mechanism that allows the medical treatment elements to perform rubbing massage operation, and a tapping drive mechanism that allows the medical treatment elements to perform tapping massage operation. The person to be treated can undergo medical treatment for upper body by the massage unit while sitting on the seat 1 and leaning against the back part 3.

The pedestal part 4 supports the seat 1 and a part of the side wall part 2.

The footrest part 5 is disposed in front of the seat 1. The footrest part 5 is attached to the pedestal part 4. The footrest part 5 may be attached to the pedestal part 4 in a fixed manner or in a movable manner. The footrest part 5 embraces lower legs and feet of the person to be treated. The footrest part 5 includes an inflatable bag that can inflate and deflate. The footrest part 5 can perform medical treatment for lower legs and feet. Note that the massage machine 100 may not include the footrest part 5.

<2. Details of Side Wall Part 2>

Specifically, each of the side wall parts 2 disposed on the left side and right side of the seat 1 includes a first side wall part 2a and a second side wall part 2b as illustrated in FIG. 1. The first side wall part 2a and the second side wall part 2b are arranged in the up and down direction.

The outer end surface of the first side wall part 2a in the left and right direction has a rectangular shape viewed from the left and right direction. One part of the first side wall part 2a protrudes upward from the seat 1, and the other part protrudes downward from the seat 1. The first side wall part 2a is supported by the pedestal part 4. The top end of the second side wall part 2b is positioned above the top end of the first side wall part 2a. Further, the front end of the second side wall part 2b is positioned behind the front end of the first side wall part 2a. Therefore, each of the left and right side wall parts 2 have a stepped shape viewed from the left and right direction.

Each of the left and right second side wall parts 2b has a rear end connected to the back part 3 so as to be integrated with the back part 3. When the back part 3 is reclined backward with the reclining mechanism, the left and right second side wall parts 2b are also reclined backward. The second side wall part 2b is disposed in a movable manner with respect to the first side wall part 2a. The left and right second side wall parts 2b and the back part 3 constitute a backrest part that supports shoulder, waist, and back of the person to be treated. Note that the massage machine 100 may not include the second side wall parts 2b.

The side wall part 2 includes a medical treatment unit 21 and an operation unit 22.

<2-1. Medical Treatment Unit 21>

The medical treatment unit 21 is a part of the massage machine 100, which performs medical treatment for a specific body part of the person to be treated sitting on the seat 1. In this embodiment, the specific body part is a forearm. In the following description, the medical treatment unit 21 may be referred to as a forearm medical treatment unit 21. Note that the specific body part may not be a forearm. For instance, the specific body part may be a shoulder, a thigh, or the like. Further, the specific body part may be a plurality of body parts.

Specifically, as illustrated in FIG. 1, the forearm medical treatment unit 21 is disposed at the first side wall part 2a out of the first side wall part 2a and the second side wall part 2b constituting the side wall part 2. Further, the forearm medical treatment unit 21 is disposed at each of the left and right first side wall parts 2a. The forearm medical treatment unit 21 disposed at the left first side wall part 2a is the forearm medical treatment unit for left arm. The forearm medical treatment unit 21 disposed at the right first side wall part 2a is the forearm medical treatment unit for right arm. The forearm medical treatment unit 21 for left arm and the forearm medical treatment unit 21 for right arm have the same structure except that they are left and right reversed. Therefore, in the following description, detailed structure of only the forearm medical treatment unit 21 for right arm is described, and description of a detailed structure of the forearm medical treatment unit 21 for left arm is omitted.

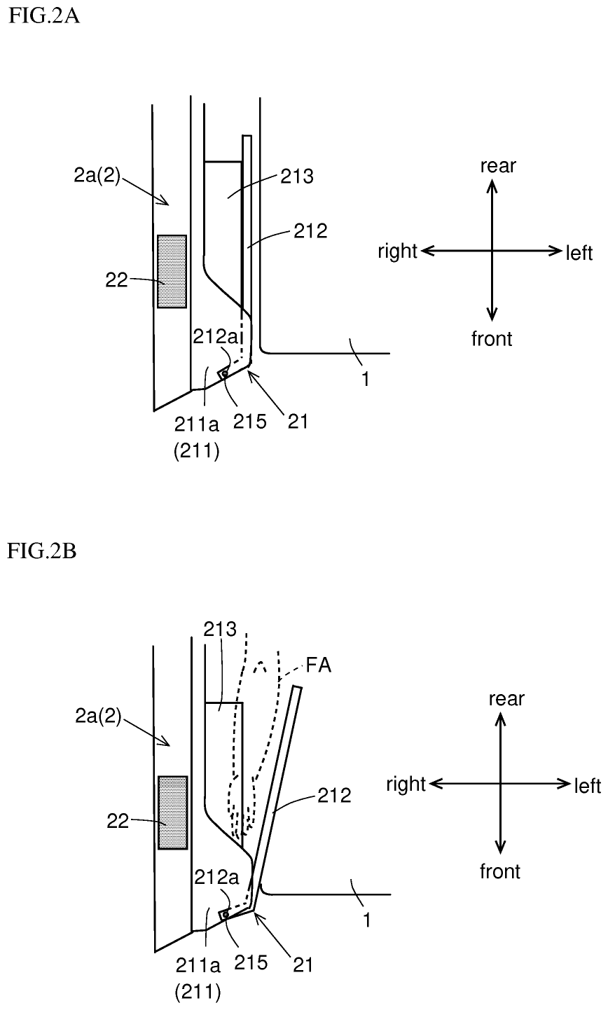

FIGS. 2A and 2B are schematic plan views illustrating the forearm medical treatment unit 21 for right arm and its vicinity. FIGS. 2A and 2B are plan views from above. The forearm medical treatment unit 21 is disposed in an openable and closable manner. FIG. 2A illustrates a state where the forearm medical treatment unit 21 is closed. FIG. 2B illustrates a state where the forearm medical treatment unit 21 is opened. In FIG. 2B, a broken line shows a forearm FA of a right arm set in the forearm medical treatment unit 21.

As illustrated in FIGS. 1, 2A, and 2B, the forearm medical treatment unit 21 includes a supporting part 211, a door part 212, and a restricting part 213.

The supporting part 211 includes an upper wall 211a, a front wall 211b, and a side wall 211c. The upper wall 211a extends inward in the left and right direction from an upper part of the partition wall 23 positioned in the middle in the left and right direction of the first side wall part 2a. The partition wall 23 extends in the front and rear direction and in the up and down direction. The front wall 211b extends inward in the left and right direction from a front part of the partition wall 23. The side wall 211c extends downward from an inner end of the upper wall 211a in the left and right direction. A front end of the side wall 211c is connected to an inner end of the front wall 211b in the left and right direction. A notch part 214 is formed in parts of the front wall 211b and the side wall 211c so as to extend from a rear end of the side wall 211c to a part of the front wall 211b.

The door part 212 is like a plate extending in the front and rear direction. Specifically, a front part of the door part 212 is bent outward. A through hole 212a is formed in the front part of the door part 212 so as to extend in the up and down direction. A shaft part 215 is inserted in the through hole 212a and is fixed to the front wall 211b. The door part 212 is supported by the supporting part 211 in a rotatable manner about the shaft part 215. In a closed state of the door part 212, the front part of the door part 212 is engaged with the notch part 214 (see FIG. 1).

The restricting part 213 extends inward in the left and right direction from the partition wall 23 of the first side wall part 2a. The restricting part 213 is positioned below the upper wall 211a. A space is formed below the restricting part 213. The restricting part 213 restricts rotation of the door part 212 in one direction. In FIGS. 2A and 2B, the restricting part 213 restricts rotation of the door part 212 in a counterclockwise direction. The top end of the door part 212 and the top end of the restricting part 213 are positioned at the same height in the up and down direction.

In the forearm medical treatment unit 21, the state where the door part 212 contacts with the restricting part 213 is the closed state (the state of FIG. 2A). Note that it is preferred that the door part 212 can maintain and release the contact state with the restricting part 213 (the closed state) using a hook, a magnet, a spring, or the like. In the forearm medical treatment unit 21, the state where the door part 212 is separated from the restricting part 213 by rotating about the shaft part 215 is the opened state (the state of FIG. 2B). The door part 212 opens laterally. It is preferred that a rotation range of the door part 212 in the opening direction should also be restricted within a certain range. Further, it is preferred that the position of the door part 212 can be fixed and released at the position after the door part 212 is rotated by a predetermined amount.

As illustrated in FIG. 2B, when medical treatment is performed for forearm of the person to be treated, the forearm medical treatment unit 21 is set to the opened state, and the forearm FA is inserted between the door part 212 and the partition wall 23. The forearm medical treatment unit 21 includes an inflatable unit that can inflate and deflate (not shown) and can perform medical treatment for the forearm FA using the inflatable unit. Note that when performing the medical treatment for the forearm FA, it may be possible that the door part 212 contacts with a body part (such as thigh or hip) of the person to be treated, so that the contacted part is also treated.

Note that in this embodiment, the forearm medical treatment unit 21 is disposed at the inside of the first side wall part 2a in the left and right direction. However, this is an example, and the forearm medical treatment unit 21 may be disposed at the outside of the first side wall part 2a in the left and right direction. Either in the case where the medical treatment unit 21 is disposed at the inside of the first side wall part 2a in the left and right direction, or in the case where it is disposed at the outside of the first side wall part 2a in the left and right direction, the medical treatment unit 21 may be disposed in a manner capable of opening and closing in the left and right direction. In the former case, because the medical treatment unit 21 is disposed to be capable of opening and closing in the left and right direction, a plurality of body parts can be affected by the medical treatment by the medical treatment unit 21. In the latter case, a width of the massage machine 100 in the left and right direction can be decreased when the massage machine 100 is not used.

<2-2. Operation Unit 22>

The operation unit 22 is provided for receiving an operation instruction from the person to be treated. The operation unit 22 includes input means such as a mechanical input key whose movable part moves when it is pressed. In addition to the input means, the operation unit 22 may include display means such as a liquid crystal display or an organic EL display. When adopting a structure in which the operation unit 22 includes the display means, the input means may be a touch panel that is integrated with the display means. The input means may include a plurality of types of input means such as a combination of the mechanical input key and the touch panel. A structural example of the operation unit 22 will be described later.

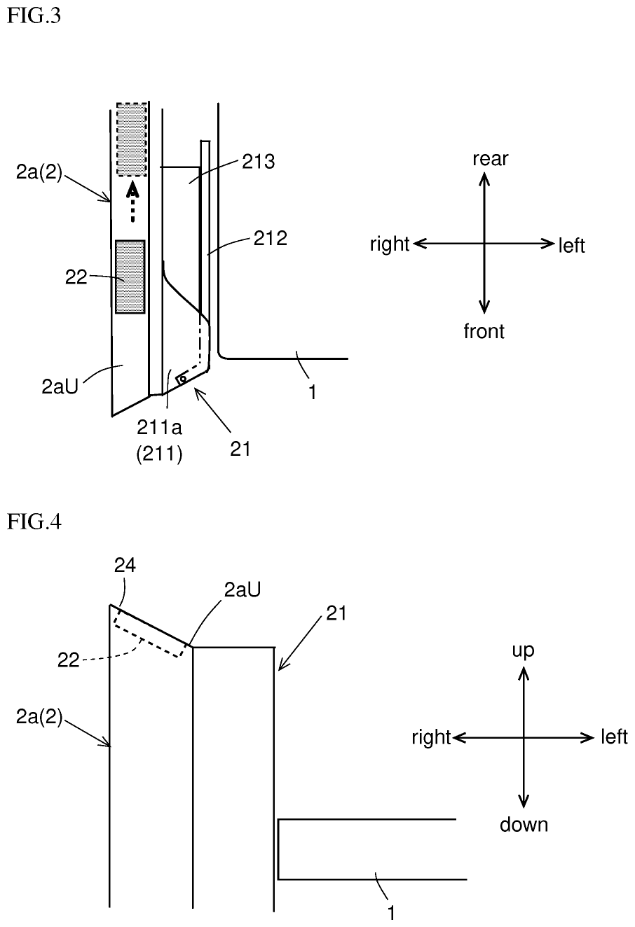

FIG. 3 is a schematic plan view illustrating the operation unit 22 and its vicinity. FIG. 3 is a diagram viewed from above. The operation unit 22 is disposed and fixed to the side wall part 2. Specifically, the operation unit 22 is disposed and fixed to the side wall part 2 with its operation surface exposed. The operation unit 22 cannot be detached from the side wall part 2. In this embodiment, the operation unit 22 is disposed only at the right side wall part 2 out of the left and right side wall parts 2. However, the operation unit 22 may be disposed only at the left side wall part 2. Further, the operation unit 22 may be disposed at each of the left and right side wall parts 2.

The operation unit 22 is close to the medical treatment unit 21. The operation unit 22 may contact with the medical treatment unit 21 or may not contact with the medical treatment unit 21. The operation unit 22 is disposed and fixed to the outside or the inside of the medical treatment unit 21 in the left and right direction. In this structure, the operation unit 22 is disposed close to the medical treatment unit 21. In other words, the operation unit 22 is close to the body of the person to be treated so that it can be easily manipulated. Further, because the operation unit 22 is disposed and fixed to the side wall part 2, the person to be treated is not required to adjust a position of the operation unit 22 every time before starting the medical treatment, so that the massage machine 100 can be operated comfortably.

In this embodiment, the operation unit 22 is disposed close to the forearm medical treatment unit 21 for right arm. Therefore, the operation unit 22 is disposed at the first side wall part 2a out of the first side wall part 2a and the second side wall part 2b constituting the right side wall part 2. However, it is sufficient that the operation unit 22 is disposed and fixed to the outside or the inside of the medical treatment unit in the left and right direction, and hence it may be disposed at the second side wall part 2b depending on a position of the medical treatment unit disposed at the side wall part 2. For instance, the operation unit 22 may be disposed at a front surface of the second side wall part 2b.

In this embodiment, a shoulder medical treatment unit 6 is disposed at the inside of each of the left and right second side wall parts 2b in the left and right direction. In other words, the side wall part 2 also includes the shoulder medical treatment unit 6. The shoulder medical treatment unit 6 is disposed in a manner capable of contacting shoulder of the person to be treated sitting on the seat 1. An inflatable bag that can inflate and deflate is embedded in the shoulder medical treatment unit 6, and hence medical treatment can be performed for shoulder of the person to be treated. The operation unit 22 may be disposed close to the shoulder medical treatment unit 6. The operation unit 22 may be disposed at the outside of the shoulder medical treatment unit 6 in the left and right direction. Note that the operation unit 22 may be disposed at least at one of the left and right second side wall parts 2b.

In this embodiment, the operation unit 22 is disposed at the outside of the medical treatment unit 21 in the left and right direction. In this way, a protection part that protects the medical treatment unit 21 (a part of the side wall part 2) is disposed at the outside of the medical treatment unit 21 in the left and right direction, and the operation unit 22 can be disposed at the protection part. Further, the operation unit 22 is disposed on the upper surface of the side wall part 2. Specifically, the operation unit 22 is disposed on an upper surface 2aU of the first side wall part 2a. In this way, the person to be treated sitting on the seat 1 can easily see and recognize the operation unit 22. Note that the operation unit 22 may be disposed at the inside of the medical treatment unit 21 in the left and right direction. In this case, the medical treatment unit 21 may be disposed at the outside of the side wall part 2 in the left and right direction.

Further, a position of the operation unit 22 in the front and rear direction is not particularly limited. In this embodiment, it is disposed near the front end of the first side wall part 2a. In this way, the operation unit 22 can be disposed at a position where the person to be treated sitting on the seat 1 can easily view. However, as illustrated by a broken line in FIG. 3, the operation unit 22 may be disposed near the rear end of the first side wall part 2a. In this way, the person to be treated can put a hand on the front of the first side wall part 2a without touching the operation unit 22, and can easily stand up without touching the operation unit 22 by accident. Further, if the operation unit 22 is disposed near the rear end of the first side wall part 2a, even if the back part 3 is reclined backward with the reclining function, the operation unit 22 can be viewed easily.

FIG. 4 is a schematic view of a part of the right first side wall part 2a, at which the operation unit 22 is disposed, viewed from the front. FIG. 4 also shows the seat 1 for easy understanding. As illustrated in FIG. 4, an inclined part 24 whose height becomes lower toward the inside in the left and right direction is disposed on the upper surface 2aU of the side wall part 2. Specifically, the inclined part 24 is disposed on the upper surface of the first side wall part 2a. The inclined part 24 is a flat surface in this embodiment, but it may be a curved surface.

The operation unit 22 is disposed at the inclined part 24. In this way, the visibility of the operation unit 22 by the person to be treated sitting on the seat 1 can be improved. Further, in this way, operability of the operation unit 22 can be improved.

<3. Details about Operation of Massage Machine 100>

FIG. 5 is a block diagram illustrating a structure of the massage machine 100 according to the embodiment of the present invention. As illustrated in FIG. 5, the massage machine 100 includes, in addition to the operation unit 22, a control unit 101, various drive units 102, and a communication unit 103.

The control unit 101 controls the entire massage machine 100. The control unit 101 is constituted of a microcomputer, for example, including a central processing unit (CPU), a read only memory (ROM), a random access memory (RAM), an input/output (I/O) circuit, and the like.

The various drive units 102 controlled by the control unit 101 include a drive unit for inflating and deflating the inflatable bags disposed in the footrest part 5, the shoulder medical treatment unit 6, the forearm medical treatment unit 21, and the like, for example. Further, the various drive units 102 controlled by the control unit 101 include a drive unit for driving the medical treatment elements of the massage unit disposed at the back part 3, and a drive unit for driving the reclining mechanism.

The control unit 101 controls the various drive units 102 to work appropriately in accordance with an operation instruction input from the operation unit 22. In this embodiment, the operation unit 22 is disposed to be capable of receiving some operations among all operations that the machine (massage machine 100) can receive externally. The operations that the massage machine 100 can receive externally include, for example, turning on and off of power supply, execution of emergency stop, start of medical treatment, adjusting of the reclining position, setting of a massage (medical treatment) position, setting of massage intensity, setting of massage time, and setting of a massage method (massage course). The some operations may be a minimum set of operations necessary for the person sitting on the seat 1. It is preferred that the some operations should include at least an emergency stop operation.

Note that the operation unit 22 may be disposed to be capable of receiving all the operations that the machine can receive externally. This structure is effective if the massage machine 100 can receive a small number of operations. If the massage machine 100 can receive a large number of operations, it is preferred that the operation unit 22 should be disposed to be capable of receiving some of the operations like this embodiment.

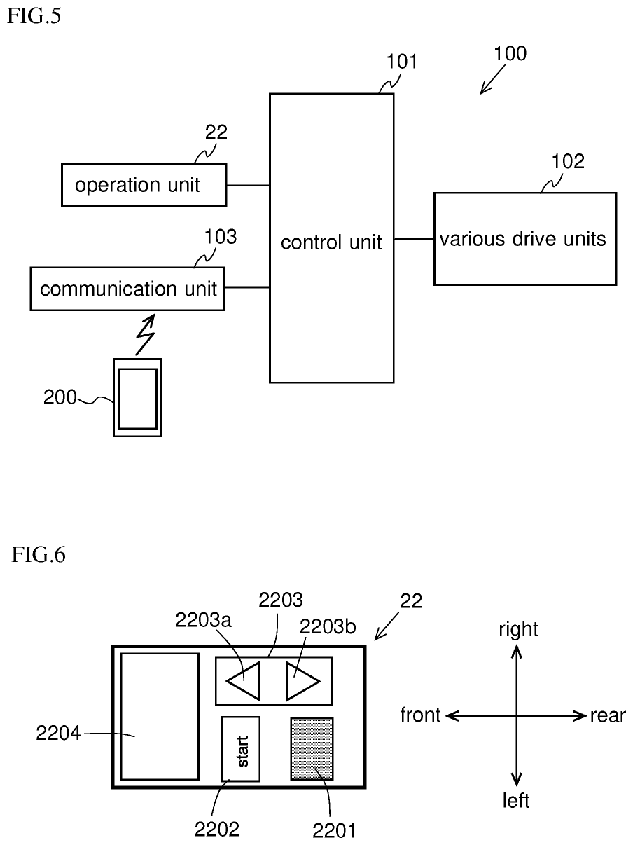

FIG. 6 is a schematic diagram illustrating a structure of the operation unit 22 of this embodiment. The operation unit 22 includes an emergency stop key 2201, a start key 2202, a reclining adjusting key 2203, and a display unit 2204.

The emergency stop key 2201 is a push button for forcibly ending the medical treatment on the way while the massage machine 100 is performing the medical treatment. The start key 2202 is a button for starting medical treatment by the massage machine 100. The reclining adjusting key 2203 is a push button for adjusting an inclination of the back part 3 in the front and rear direction. The reclining adjusting key 2203 includes a key 2203a for restoring the back part 3 forward and a key 2203b for reclining the back part 3 backward.

The display unit 2204 displays simple messages. For instance, the display unit 2204 displays a message whether or not medical treatment can be started, content of error when the error has occurred, and the like.

In this embodiment, the massage machine 100 can be controlled by an operation device disposed in a movable manner separately from the operation unit 22. In the following description, the operation device disposed in a movable manner may be referred to as a non-fixed type operation device. Specifically, the massage machine 100 is configured so that, among all the operations that the machine can receive externally, at least operations other than the some operations described above can be received by the non-fixed type operation device. In this way, the person to be treated or other person can input for detailed settings, such as setting of medical treatment conditions using the massage machine 100, while viewing the non-fixed type operation device at hand. Further, the person to be treated or other person can input operation instructions with the non-fixed type operation device while sitting on the seat 1 or being at a different position from the seat 1.

Note that the non-fixed type operation device may be disposed to be capable of receiving at least some of the operations that can be received by the operation unit 22. Further, the non-fixed type operation device may be disposed to be capable of receiving all the operations that the machine can receive externally.

In this embodiment, the operation device (non-fixed type operation device) is a mobile terminal 200. It is sufficient that the mobile terminal 200 is a mobile terminal device that can input operation instructions via a wireless communication with the massage machine 100, such as a smartphone or a tablet terminal. Further, the mobile terminal 200 may be a mobile terminal that cannot connect to the Internet, which is dedicated to the massage machine 100. Further, the non-fixed type operation device may be a remote controller connected to the control unit 101 via wired communication.

The communication unit 103 performs wireless communication with the mobile terminal 200. A method of wireless communication is not particularly limited. The method of wireless communication may be a method using Wi-Fi (trademark) or a method using Bluetooth (trademark), for example. An operation instruction input via the mobile terminal 200 is input to the control unit 101 via the communication unit 103. The control unit 101 controls the various drive units 102 to work appropriately in accordance with the operation instruction input from the mobile terminal 200.

With the structure of this embodiment, the person to be treated or other person can perform setting of medical treatment conditions or the like in the massage machine 100, using the mobile terminal 200 such as a smartphone, in which predetermined application software for the massage machine 100 is installed, for example. With the structure using the mobile terminal 200, the person to be treated or other person can perform input operation also at a position apart from the massage machine 100, and this is convenient. On the other hand, the massage machine 100 is provided with the operation unit 22 that receives main operation instructions such as emergency stop and start, which is necessary for a person who sits on the seat 1. Therefore, the person to be treated can use the operation unit 22 and the mobile terminal 200 for different ways of inputting operation instructions in accordance with situations, and hence the massage machine 100 can be appropriately operated.

<4. Summary>

As described above, the massage machine 100 as an example of the present invention includes the seat 1 on which the person to be treated sits, and the side wall part 2 disposed at the outside of the seat 1 in the left and right direction. The side wall part 2 includes the medical treatment unit 21 that performs medical treatment for a specific body part of the person to be treated sitting on the seat 1, and the operation unit 22 disposed and fixed to the outside or the inside of the medical treatment unit 21 in the left and right direction.

In the massage machine 100 having the structure described above, the specific body part is a forearm, and the operation unit 22 may be disposed on an upper surface of the side wall part 2.

In the massage machine 100 having the structure described above, the medical treatment unit 21 may be disposed in a manner capable of opening and closing in the left and right direction.

In the massage machine 100 having the structure described above, the side wall part 2 includes the inclined part 24 whose height becomes lower toward the inside in the left and right direction on the upper surface, and the operation unit 22 may be disposed at the inclined part 24.

In the massage machine 100 having the structure described above, the operation unit 22 is disposed to be capable of receiving some operations among all operations that the machine can receive externally, and the massage machine 100 may be configured to be capable of being operated by the operation device 200 disposed in a movable manner separately from the operation unit 22.

In the massage machine 100 having the structure described above, the operation device 200 disposed separately is a mobile terminal, and the massage machine 100 may be configured to further include a communication unit 103 for performing wireless communication with the mobile terminal 200.

<5. Notes>

Besides the embodiment described above, various technical features disclosed in this specification can be modified variously within the scope without deviating from the spirit of the technical invention. In other words, the embodiment described above is merely an example in every aspect and should not be interpreted as limitations. The technical scope of the present invention is defined not by the above description of the embodiment, but by the claims, and should be understood to include all modifications within the meaning and the scope equivalent to the claims. Further, the plurality of embodiments and variations described in this specification can be combined appropriately in the possible range.

What is claimed is:

1. A massage machine comprising:
a seat on which a person to be treated sits; and
a side wall part disposed at an outside of the seat in a left and right direction, wherein
the side wall part includes a medical treatment unit configured to perform medical treatment for a specific body part of the person to be treated sitting on the seat, and an operation unit disposed and fixed to an outside or an inside of the medical treatment unit in the left and right direction.

2. The massage machine according to claim 1, wherein
the specific body part is a forearm, and
the operation unit is disposed on an upper surface of the side wall part.

3. The massage machine according to claim 2, wherein the medical treatment unit is disposed in a manner capable of opening and closing in the left and right direction.

4. The massage machine according to claim 2, wherein
the side wall part includes an inclined part whose height becomes lower toward the inside in the left and right direction on the upper surface, and
the operation unit is disposed at the inclined part.

5. The massage machine according to claim 1, wherein
the operation unit is disposed to be capable of receiving some operations among all operations that the machine can receive externally, and
the massage machine is configured to be capable of being operated by an operation device disposed in a movable manner separately from the operation unit.

6. The massage machine according to claim 5, wherein
the operation device is a mobile terminal, and
the massage machine further comprises a communication unit for performing wireless communication with the mobile terminal.
